(19) United States
(12) Patent Application Publication
(10) Pub. No.: US 2023/0095737 A1
(43) Pub. Date: Mar. 30, 2023

(54) MOTOR-DRIVEN VEHICLE INCLUDING CONTINUOUSLY VARIABLE TRANSMISSION AND CONTROL METHOD THEREOF

(71) Applicant: Honda Motor Co., Ltd., Tokyo (JP)

(72) Inventor: Toru YAGASAKI, Tokyo (JP)

(73) Assignee: Honda Motor Co., Ltd., Tokyo (JP)

(21) Appl. No.: 17/878,065

(22) Filed: Aug. 1, 2022

(30) Foreign Application Priority Data
Sep. 30, 2021 (JP) 2021-162300

(51) Int. Cl. B60W 20/14; B60W 10/08; B60W 10/101; B60W 20/30

(52) U.S. Cl. CPC B60W 20/14; B60W 10/08; B60W 10/101; B60W 20/30; B60W 2710/083; B60W 2710/105

(57) ABSTRACT

Provided are a motor-driven vehicle capable of releasing restrictions on operating conditions and having good acceleration, regeneration, and slope climbing abilities, and a control method thereof. A motor-driven vehicle includes: an electric motor; a continuously variable transmission provided between the electric motor and a drive wheel; and a control part that executes a torque control of the electric motor and a shift control of the continuously variable transmission. The control part has a control area for the shift control in which an output torque of the continuously variable transmission at the time of a peak torque of the electric motor and the output torque of the continuously variable transmission at the time of a rated torque of the electric motor are substantially equal.

### CROSS-REFERENCE TO RELATED APPLICATION

This application claims the priority benefit of Japan application serial no. 2021-162300, filed on Sep. 30, 2021. The entirety of the above-mentioned patent application is hereby incorporated by reference herein and made a part of this specification.

### BACKGROUND

### Technical Field

The disclosure relates to a vehicle whose drive source is an electric motor, and more particularly to a control technique for a motor-driven vehicle including a continuously variable transmission.

### Related Art

In vehicles traveling by driving an electric motor, efficiency of power transmission and electric power consumption is always an important issue in order to extend the cruising range, and various techniques have been proposed for that purpose.

For example, the electric vehicle disclosed in Patent Literature 1 is provided with a direct gear mechanism that transmits the rotation of the electric motor to the drive wheels without passing through a continuously variable transmission (CVT), and the power transmission efficiency is improved by using a direct gear mechanism when traveling at high speed on a highway or the like.

Patent Literature 2 discloses a power train in which a reduction gear mechanism is provided between an electric motor and an input shaft of a CVT and between an output shaft of the CVT and a drive wheel. With this reduction gear mechanism, even if an electric motor with a low peak torque output is used, the peak torque does not substantially decrease, and it is possible to reduce the size and weight of the electric motor, thereby improving the electric power consumption efficiency and operating efficiency.

### CITATION LIST

### Patent Literature

[Patent Literature 1] Japanese Patent Laid-Open Publication No. 5977458
[Patent Literature 2] International Patent Application Laid-Open No. 2020/057779

The above-mentioned Patent Literature 1 is a technique for improving the power transmission efficiency during high-speed operation, but it is known that there are various problems in a situation where an electric motor generates a high regenerative torque in a low-speed rotation state.

First, there are two types of torque characteristics of an electric motor: a peak (PEAK) torque characteristic that does not allow steady operation and a rated (CONT) torque characteristic that allows steady operation. The PEAK torque is the maximum torque that may be used in an instant (in a short time), and is the maximum torque that may be used during acceleration or deceleration. The CONT torque is the rated output of the electric motor, the torque output when operating at the rated rotation speed, that is, the torque that may be used continuously.

As an example, as shown in FIG. 1, the change in the driving force with respect to the speed at the time of the PEAK torque is shown as the curve A; the change in the driving force with respect to the speed at the time of the CONT torque is shown as the curve B; and the change in the torque required by the vehicle with respect to the speed is shown as the curve C. In the example of FIG. 1, when the driving force (curve C) at the time of torque required by the vehicle exceeds the driving force at the time of the CONT torque (area D) at low speed, especially at the time of slope climbing, the CONT torque is insufficient, and the PEAK torque is requested. However, if a large amount of the PEAK torque, which does not allow steady operation regardless of the presence or absence of a continuously variable transmission, is used, it is necessary to set a limit on the operating state, which is not desirable.

In the electric vehicle disclosed in Patent Literature 2, by providing a reduction gear mechanism, the CONT torque may be increased even in a low-speed rotation state, and it is possible to generate a driving force at the time of the CONT torque to be higher than the torque required by the vehicle (curve C) even when climbing a slope. However, it is not possible to obtain a driving force at the time of the CONT torque with a margin simply by the downsizing of the electric motor and the reduction gear mechanism disclosed in Patent Literature 2. For this reason, depending on the operating conditions, there is a possibility that the electric motor may be used in a situation where a high regenerative torque is generated in a low-speed rotation state, and it is necessary to set restrictions on the operating conditions.

Therefore, the disclosure provides a motor-driven vehicle capable of releasing restrictions on operating conditions and having good acceleration, regeneration, and slope climbing abilities, and a control method thereof.

### SUMMARY

A motor-driven vehicle according to an embodiment of the disclosure includes: an electric motor (1); a continuously variable transmission (40) provided between the electric motor (1) and a drive wheel (2); and a control part (51) that executes a torque control of the electric motor (1) and a shift control of the continuously variable transmission (40). The control part (51): includes a control area (S2) for the shift control in which an output torque of the continuously variable transmission (40) at the time of a peak (PEAK) torque of the electric motor (1) and the output torque of the continuously variable transmission (40) at the time of a rated (CONT) torque of the electric motor (1) are equal, sets an extra low ratio (Extra-Low) lower than a lowest ratio (Low) in a predetermined ratio range (Low to OD) for the continuously variable transmission (40), and when the peak torque is requested in the electric motor (1), downshifts a ratio of the continuously variable transmission (40) from the lowest ratio (Low) to the extra low ratio (Extra-Low) while reducing an output torque of the electric motor (1) from the peak torque to the rated torque in the control area.

As a result, the shift control is performed so that the continuously variable transmission has the same output torque at the time of the peak torque and at the time of the rated torque of the electric motor; therefore, it is possible to avoid the situation where the electric motor is frequently used at the peak torque, and restrictions on the operating conditions may be released.

Further, when the peak torque is requested, the peak torque is reduced to the rated torque and it is downshifted to the extra low ratio (Extra-Low), whereby the situation where the electric motor (1) is frequently used at the peak torque may be avoided, and the regeneration, slope climbing and acceleration abilities may be improved.

In a control method of a motor-driven vehicle according to an embodiment of the disclosure, the motor-driven vehicle includes: an electric motor; a continuously variable transmission provided between the electric motor and a drive wheel; and a control part that executes a torque control of the electric motor and a shift control of the continuously variable transmission. The control part: includes a control area for the shift control in which an output torque of the continuously variable transmission at the time of a peak torque of the electric motor and the output torque of the continuously variable transmission at the time of a rated torque of the electric motor are equal, sets an extra low ratio lower than a lowest ratio in a predetermined ratio range for the continuously variable transmission, and when the peak torque is requested in the electric motor, downshifts a ratio of the continuously variable transmission from the lowest ratio to the extra low ratio while reducing an output torque of the electric motor from the peak torque to the rated torque in the control area. As a result, the shift control is performed so that the continuously variable transmission (40) has the same output torque at the time of the peak torque and at the time of the rated torque of the electric motor (1); therefore, it is possible to avoid the situation where the electric motor (1) is frequently used at the peak torque, and restrictions on the operating conditions may be released.

Further, when the peak torque is requested, the peak torque is reduced to the rated torque and it is downshifted to the extra low ratio (Extra-Low), whereby the situation where the electric motor (1) is frequently used at the peak torque may be avoided, and the regeneration, slope climbing and acceleration abilities may be improved.

### BRIEF DESCRIPTION OF THE DRAWINGS

FIG. 1 is a graph showing the relationship between the speed of a vehicle and a driving force in a continuously variable transmission in the conventional technique with the torques of an electric motor as parameters.

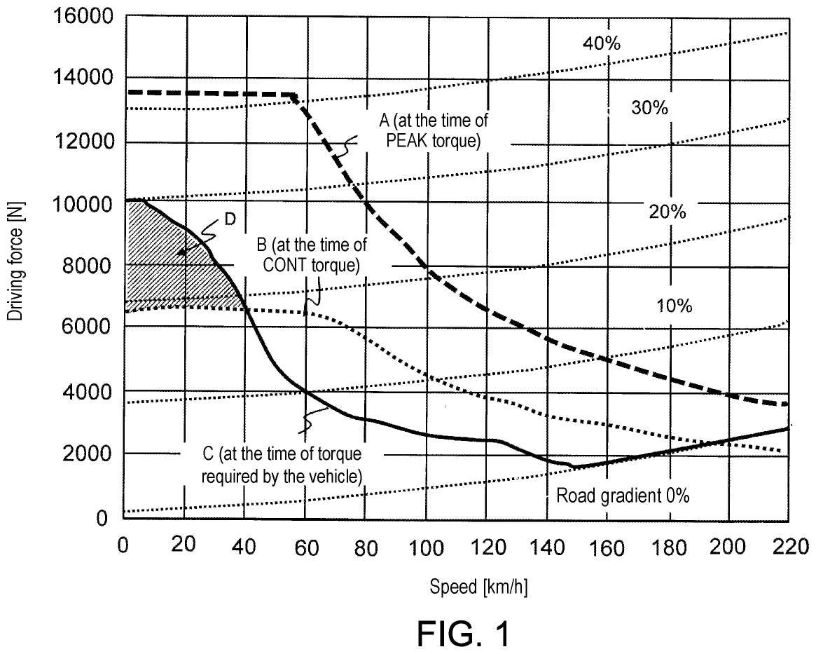

FIG. 2 is a diagram showing a configuration of a continuously variable transmission for an electric vehicle according to a first embodiment of the disclosure.

FIG. 3 is a diagram showing an example of a CVT ratio of a continuously variable transmission according to the first embodiment.

FIG. 4 is a flowchart showing a shift control method of the continuously variable transmission according to the first embodiment.

FIG. 5 is a graph showing the relationship between the rotation speed and torque of the electric motor output and the CVT output in the continuously variable transmission according to the first embodiment.

FIG. 6 is a graph showing the relationship between the vehicle speed and the driving force in the continuously variable transmission according to the first embodiment, with the torques of the electric motor as parameters.

FIG. 7 is a diagram showing a configuration of a continuously variable transmission for an electric vehicle according to a second embodiment of the disclosure.

FIG. 8 is a diagram showing a configuration of a continuously variable transmission for an electric vehicle according to a third embodiment of the disclosure.

### DESCRIPTION OF THE EMBODIMENTS

According to an embodiment of the disclosure, when the peak torque is requested in the electric motor (1), the control part (51): sets the output torque of the electric motor (1) to the peak torque, reduces the output torque of the electric motor (1) from the peak torque to the rated torque and downshifts the ratio of the continuously variable transmission (40) from the lowest ratio (Low) to the extra low ratio (Extra-Low), and when a request for the peak torque in the electric motor (1) is released, increases the ratio of the continuously variable transmission (40) from the extra low ratio (Extra-Low) to the lowest ratio (Low) in the predetermined ratio range.

As a result, when the peak torque is requested, the electric motor may be immediately set to the peak torque and high torque may be output from the continuously variable transmission, and then the electric motor may be returned to the rated torque while a high torque may be maintained, and the electric motor may be driven at the rated torque until the request for the peak torque is released.

According to an embodiment of the disclosure, the peak torque is requested in the electric motor during slope climbing, regeneration, or acceleration of the motor-driven vehicle. As a result, good regeneration, slope climbing and acceleration abilities may be achieved.

According to an embodiment of the disclosure, a reduction mechanism (31) may be provided between an output shaft of the electric motor (1) and an input shaft of the continuously variable transmission (40). As a result, the peak torque of the electric motor may be reduced, and the size and weight of the electric motor may be reduced.

According to an embodiment of the disclosure, the electric motor (1) may be used in an electric vehicle mode of a hybrid vehicle. The disclosure may be applied regardless of whether the motor-driven vehicle is an electric vehicle or a hybrid vehicle.

The reference numerals in the parentheses above refer to the reference numerals in the drawings of the corresponding components in the embodiments to be described later for reference.

According to the disclosure, it is possible to avoid the frequent use of the electric motor at the peak torque, and the restrictions on the operating conditions may be released, and the regeneration, slope climbing and acceleration abilities may be improved.

Hereinafter, embodiments of the disclosure will be described in detail with reference to the drawings. However, the components described in the following embodiments are merely examples, and the technical scope of the disclosure is not limited to them.

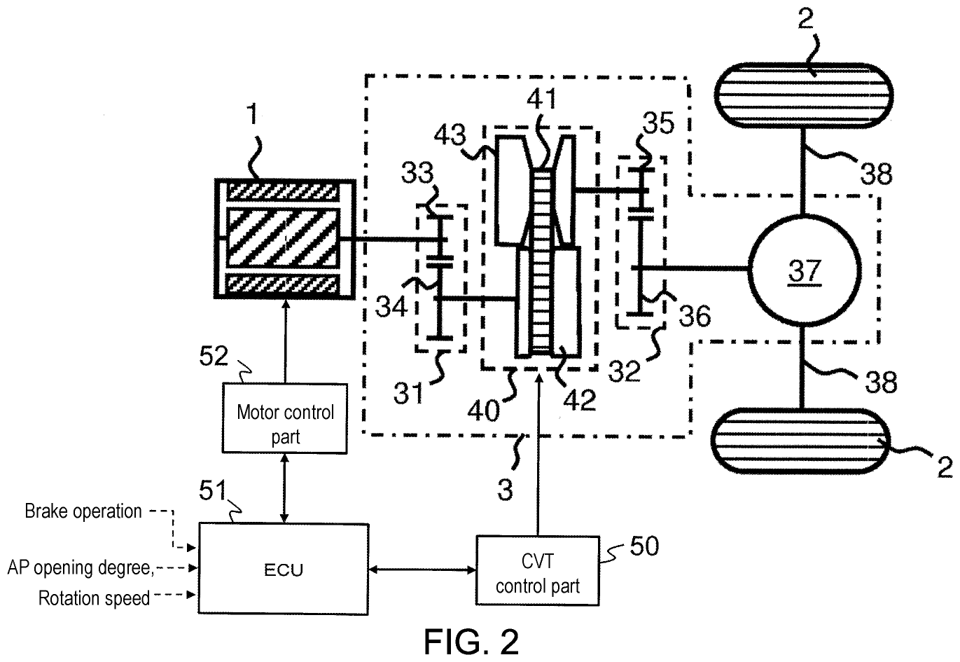

As shown in FIG. 2, a motor-driven vehicle including a continuously variable transmission according to the first embodiment of the disclosure includes an electric motor 1 known as an electric motor/generator, drive wheels 2, and a gear mechanism 3 that connects the electric motor 1 to the drive wheels 2. The gear mechanism 3 includes a first reduction mechanism 31, a second reduction mechanism 32, a differential gear 37, and a continuously variable transmission (CVT) 40. The first reduction mechanism 31 is provided between the electric motor 1 and the input shaft of the CVT 40. The first reduction mechanism 31 is configured by meshing gears 33 and 34 in series, and the gear 33 is directly connected to the rotation shaft of the electric motor 1, and the rotation shaft of the gear 34 is directly connected to the input shaft of an input pulley 42 of the CVT 40. Therefore, the electric motor 1 used in this embodiment has a PEAK torque characteristic in which the maximum torque corresponding to the reduction ratio of the first reduction mechanism 31 is reduced.

The second reduction mechanism 32 is provided between the output shaft of the CVT 40 and the differential gear 37. The second reduction mechanism 32 is configured by meshing gears 35 and 36 in series, and the gear 35 is directly connected to the output shaft of an output pulley 43 of the CVT 40, and the gear 36 is directly connected to the differential gear 37. The rotation of the gear 36 is transmitted to the drive wheels 2 through the differential gear 37 and a drive shaft 38.

The CVT 40 has a known configuration in which a belt 41 wraps around the input pulley 42 and the output pulley 43, and the effective radii of the belt 41 and the pulleys 42 and 43 change in opposite directions between the pulleys 42 and 43, whereby a desired ratio (rotation speed ratio) may be continuously obtained. According to this embodiment, normal operation may be performed by continuously changing the ratio of the CVT 40 within a predetermined ratio range, but when a PEAK torque output is requested in the electric motor 1, an extra low ratio that is further downshifted from the lowest ratio in the normal predetermined ratio range is set and shift control is performed. Details will be described later.

The CVT control part 50 executes a shift control of the CVT 40 by changing the effective radii of the pulleys 42 and 43 by hydraulic control or the like according to the control of an electronic control unit (ECU) 51 that manages the operation of the vehicle. Further, a motor control part 52 controls the torque, the rotation speed, and the like of the electric motor 1 according to a motor torque command from the ECU 51. The ECU 51 controls the CVT control part 50 and the motor control part 52 while monitoring the brake operation, the access opening degree, the rotation speed of the motor and the pulley, and the like.

In FIG. 2, the battery, the inverter, and the like for supplying electric power to the electric motor 1 and charging during the regenerative operation is omitted from the drawing.

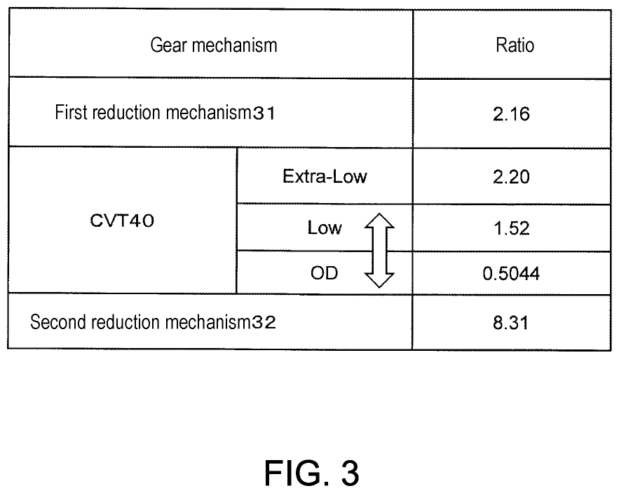

FIG. 3 shows an example of the ratio of the first reduction mechanism 31, the second reduction mechanism 32, and the CVT 40 described above. The ratios of the first reduction mechanism 31 and the second reduction mechanism 32 are fixed, but the ratio of the CVT 40 continuously changes between Low (lowest) and OD (highest), and may perform normal operation this continuous ratio range. In the example shown in FIG. 3, the Low ratio is 1.52, and the OD ratio is 0.5044, and the effective rolling radius of the tire is 0.4088 (m). According to this embodiment, the ratio of Extra-Low (extra low) in which the CVT 40 is further downshifted from Low is set. In FIG. 3, the ratio of Extra-Low is 2.20. When the ECU 51 is required to climb a slope, regenerate, accelerate, or the like and the PEAK torque is requested, the ECU 51 controls the CVT control part 50 to change the CVT 40 between Low and Extra-Low as described below, and the motor control part 52 is controlled to change the output torque of the electric motor 1 between CONT and PEAK

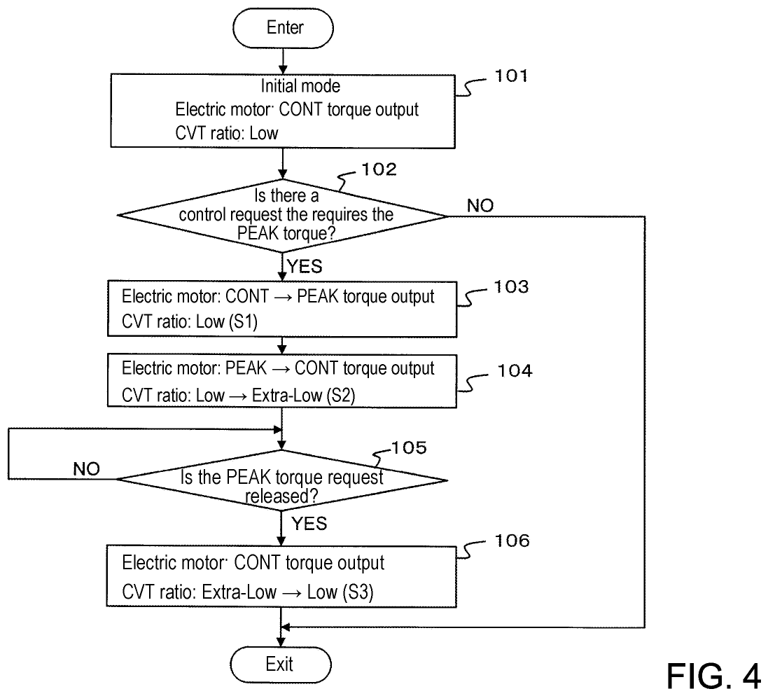

In FIG. 4, the ECU 51 sets the electric motor 1 to the CONT torque output and sets the ratio of the CVT 40 to Low as an initial mode (operation 101). When the PEAK torque is requested in response to a request for slope climbing, regeneration, acceleration, or the like (YES in operation 102), the ECU 51 increases the torque output of the electric motor 1 from the CONT torque to the PEAK torque while the CVT ratio is Low (operation 103). By increasing the torque output of the electric motor 1, it is possible to quickly respond to the request for the PEAK torque.

Subsequently, the ECU 51 shifts down the CVT ratio from Low to Extra-Low while reducing the torque output of the electric motor 1 from PEAK to CONT (operation 104), and holds this state until the PEAK torque request is released (NO in operation 105). By shifting down the CVT ratio from Low to Extra-Low, it is possible to maintain the output torque of the CVT 40 without reducing it even if the torque output of the electric motor 1 is reduced from PEAK to CONT. Further, since the torque output of the electric motor 1 may be reduced from PEAK to CONT in an instant or in a short time, the electric motor 1 may limit the PEAK torque state within a desired time. In other words, the torque output of the electric motor 1 is maintained at the CONT torque until the PEAK torque request is released, so that the problem of frequently using the electric motor 1 in the PEAK torque state may be avoided.

Subsequently, when the PEAK torque request is released (YES in operation 105), the ECU 51 shifts up the CVT ratio from Extra-Low to Low while maintaining the torque output of the electric motor 1 at CONT (operation 106).

When the PEAK torque is not requested (NO in operation 102), the ECU 51 does not perform a shift control according to this embodiment and performs a shift control continuous within a predetermined ratio range of the CVT ratio Low to OD as shown in FIG. 3.

As described above, by shifting down the CVT ratio to Extra-Low when climbing a slope or regenerating where the PEAK torque is requested, it is possible to set an area in which the CVT output torque at the time of the electric motor PEAK torque and the CVT output torque at the time of the electric motor CONT torque are matched.

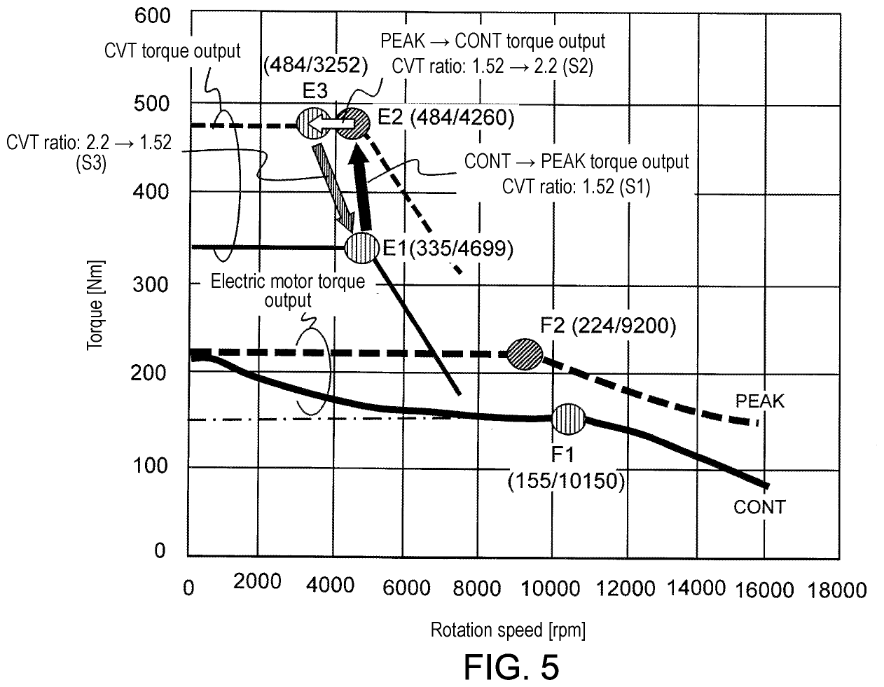

Hereinafter, an example of the above-mentioned shift control (operations 103 to 106 in FIG. 4) will be described with reference to FIG. 5. FIG. 5 shows a change in the PEAK/CONT torque output of the electric motor 1 with respect to the rotation speed of the electric motor 1 and a change in the torque output of the CVT 40 corresponding to the electric motor PEAK/CONT torque output, respectively. Here, the rotation speed is the X axis, and the torque is the Y axis, and any operating point is expressed as (X/Y).

Specifically, an operating point F1 on the CONT torque curve of the electric motor 1 indicates the CONT torque output 155 [Nm] of the electric motor 1 at a rotation speed of 10150 [rpm], and an operating point F2 on the PEAK torque curve indicates the PEAK torque output 244 [Nm] of the electric motor 1 at a rotation speed of 9200 [rpm]. When the CVT ratio is a constant value (here, 1.52=Low), the operating point of the CVT 40 when the electric motor 1 operates at the CONT torque operating point F1 is E1 (335/4699), and the operating point of the CVT 40 when the electric motor 1 operates at the PEAK torque operating point F2 is E2 (484/4260).

According to this embodiment, when the CVT 40 is at the operating point E2, the CVT ratio is changed from Low to Extra-Low even if the torque output of the electric motor 1 is reduced from PEAK (F2) to CONT (F1), whereby it is possible to shift to an operating point E3 while maintaining the torque output (484 [Nm]) of the operating point E2 of the CVT 40. Hereinafter, operations S1 to S3 of FIG. 5 will be described in association with the operations 103 to 106 of FIG. 4.

In FIG. 5, when the PEAK torque is requested due to the request for slope climbing, regeneration, acceleration, or the like, the ECU 51 changes the torque output of the electric motor 1 from the CONT torque (F1) to the PEAK torque (F2) in the state of CVT ratio=Low (1.52), and the operating point of the CVT torque output is changed from E1 to E2 (operation S1; operation 103 in FIG. 4).

Subsequently, the ECU 51 shifts down the CVT ratio from Low (1.52) to Extra-Low (2.2) while reducing the torque output of the electric motor 1 from PEAK (F2) to CONT (F1), whereby the operating point E2 of the CVT torque output is changed to the operating point E3 (operation S2; operation 104 in FIG. 4). This makes it possible to match the torque output of the CVT 40 with the torque output of the operating point E2 even if the torque output of the electric motor 1 is reduced from PEAK to CONT.

Subsequently, when the PEAK torque request is released, the ECU 51 shifts up the CVT ratio from Extra-Low (2.2) to Low (1.52) while maintaining the torque output of the electric motor 1 at CONT (operation S3; operation 106 in FIG. 4). In this way, by shifting down the CVT ratio to Extra-Low during slope climbing, regeneration, or acceleration that requires the PEAK torque, it is possible to set an area in which the CVT output torque at the time of the electric motor PEAK torque and the CVT output torque at the time of the electric motor CONT torque are matched.

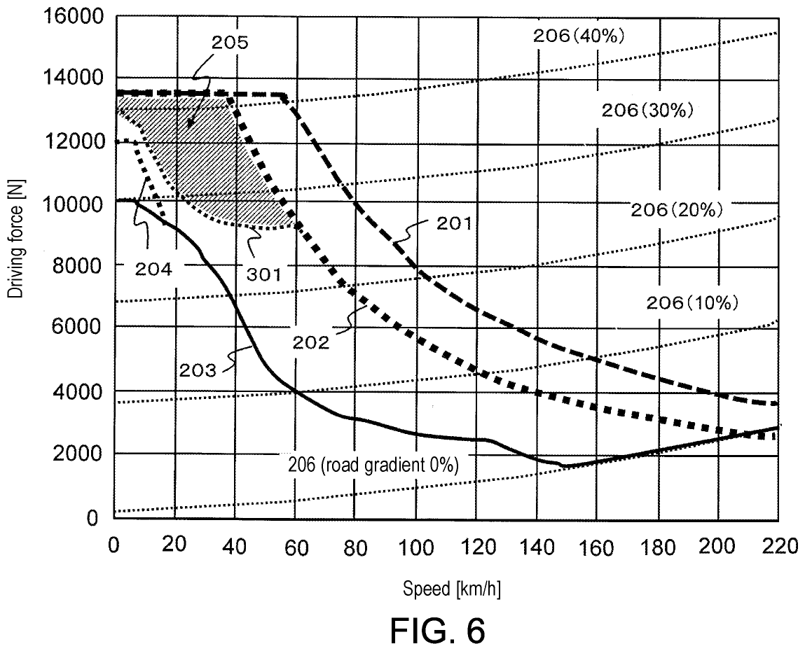

The effect of shift control using Extra-Low according to the first embodiment described above will be described with reference to FIG. 6.

In FIG. 6, the change in the driving force with respect to the speed at the time of the PEAK torque is the curve 201, and the change in the driving force with respect to the speed at the time of the CONT torque according to this embodiment is the curve 202, and the change in the driving force required by the vehicle with respect to the speed is the curve 203. Further, the curve 301 is the change in the driving force at the time of the CONT torque when the CONT torque is increased by the reduction gear mechanism (Patent Literature 2) in the low speed rotation state.

According to the shift control of this embodiment, by using Extra-Low, it is possible to set the driving force area 205 at the time of the CONT torque, which is sufficiently higher than the driving force curve 301 at the time of the CONT torque using the reduction gear mechanism. With this driving force area 205, it is possible to obtain a driving force curve 202 at the time of the CONT torque, which is sufficiently larger than the driving force curve 203 required by the vehicle. In particular, even when a further driving force is required when climbing a slope at a low speed, such as when accelerating at 0.5 m/sec² for a 30% gradient as shown by the curve 204, the driving force at the time of the CONT torque that is sufficiently high due to the shift control according to this embodiment may be obtained.

More specifically, in FIG. 6, the change in traveling resistance with respect to speed is shown by the curve 206 for each road gradient. The unit of traveling resistance is Newton (N), and the unit of road gradient is percentage (%). The road gradient is a percentage display of the value obtained by dividing the vertical distance by the horizontal distance. For example, the road gradient of 30% indicates an uphill that rises by 30 m when traveling 100 m. In FIG. 6, the curve 206 of the traveling resistance indicates that the vehicle cannot be driven unless a driving force greater than or equal to the curve is generated. Therefore, in the case of the driving force curve 301 at the time of the CONT torque using the reduction gear mechanism, it is not possible to obtain a speed of 40 km/h when traveling uphill with a gradient of 30%. On the other hand, according to this embodiment, since the driving force curve 202 at the time of the CONT torque that is sufficiently large may be obtained, 40 km/h may be achieved with a margin even at a gradient of 30%.

As described above, according to this embodiment, the CVT output torque at the time of the electric motor CONT torque may be set to be equal to the CVT output torque at the time of the electric motor PEAK torque by shifting down the CVT ratio to Extra-Low during slope climbing, regeneration or acceleration when the PEAK torque is requested. This eliminates the need to use a large amount of the PEAK torque that does not allow a steady operation, and may provide a motor-driven vehicle having good acceleration, regeneration, and slope climbing abilities without limiting operating conditions.

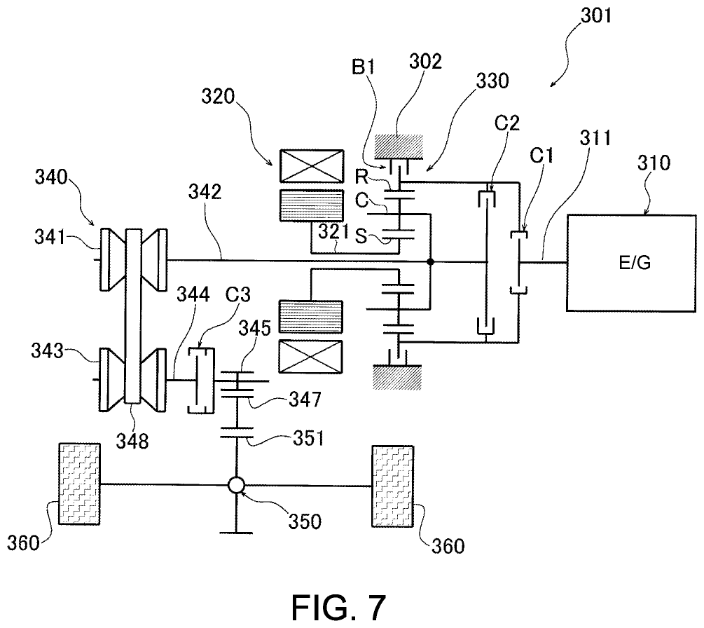

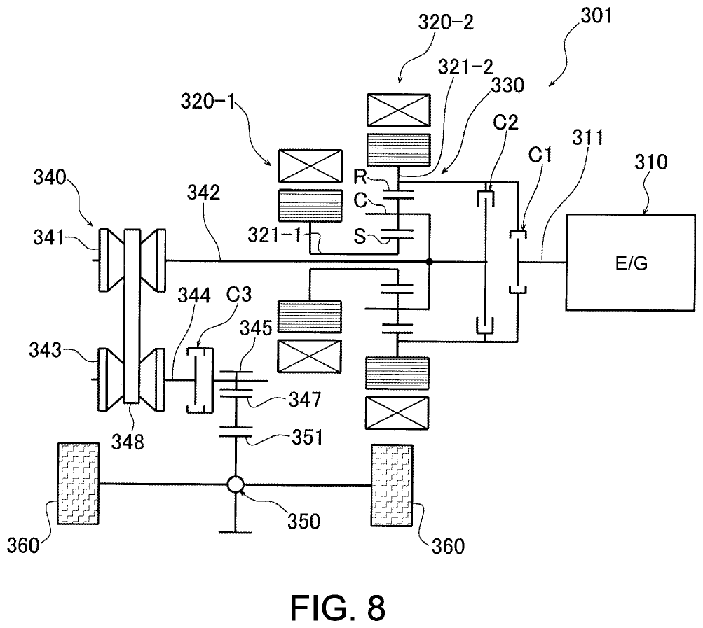

The motor-driven vehicle according to the disclosure is not limited to an electric vehicle that travels only by an electric motor, but may also be applied to a hybrid vehicle that may travel by an electric motor. FIG. 7 shows a schematic configuration of a hybrid vehicle according to a second embodiment of the disclosure, and FIG. 8 shows a schematic configuration of a hybrid vehicle according to a third embodiment. Hereinafter, the parts having the same configurations and functions in FIGS. 7 and 8 will be described with the same reference numerals.

In FIG. 7, a hybrid drive device 301 to which the second embodiment of the disclosure is applied includes an engine 310 that generates power by burning fuel, an electric motor 320 that functions as an electric motor and a generator, a single pinion type planetary gear mechanism (planetary gear) 330 having three elements including a sun gear S, a ring gear R and a carrier C, and a belt type CVT 340 having a belt 348 spanned between a drive pulley 341 and a driven pulley 343.

An output shaft (rotation shaft) 321 of the electric motor 320 is connected to the sun gear S of the planetary gear mechanism 330, and an input shaft (first rotation shaft) 342 connected to the drive pulley 341 of the CVT 340 is connected to the carrier C. Further, the ring gear R is connected to an output shaft 311 of the engine 310 via a first clutch C1 and is also connected to the input shaft 342 of the CVT 340 via a second clutch C2. Further, the ring gear R may be fixed to a case (fixed side member) 302 accommodating the hybrid drive device 301 via a brake B1.

Further, an output gear 345 that meshes with a counter gear 347 is provided on an output shaft (second rotation shaft) 344 connected to the driven pulley 343 of the CVT 340. The counter gear 347 meshes with a ring gear 351 of a differential device 350. The differential device 350 distributes the driving force from the counter gear 347 to left and right drive wheels 360 and 360. A third clutch C3 is provided on the output shaft 344 of the CVT 340 (between the driven pulley 343 and the output gear 345).

That is, in the planetary gear mechanism 330 of the hybrid drive device 301 shown in FIG. 7, the sun gear S to which the output shaft 321 of the electric motor 320 is connected and the ring gear R to which the output shaft 311 of the engine 310 is connected are input members; the carrier C connected to the input shaft 342 of the CVT 340 is an output member. Then, the engagement/disengagement of the output shaft 311 of the engine 310 and the ring gear R may be switched by the first clutch C1, and the engagement/disengagement between the carrier C and the ring gear R may be switched by the second clutch C2. Further, the transmission or non-transmission of the driving force from the CVT 340 to the drive wheels 360 and 360 side may be switched by the third clutch C3. Although detailed illustration is omitted, single-plate or multi-plate hydraulic friction clutches configured to be frictionally engaged by a hydraulic actuator may be used for the first to third clutches C1 to C3 and the brake B1. In addition, an electromagnetic clutch or the like may be used.

In the hybrid drive device 301, each traveling mode is established according to the operating state (engagement/disengagement state) of the first to third clutches C1 to C3 and the brake B1. The shift control according to this embodiment is executed in the following “motor traveling mode (forward deceleration).” Such control and shift control of the hybrid drive device 301 are executed by an ECU 51 (not shown).

In the “motor traveling mode (forward deceleration),” the electric motor 320 is driven in the forward direction with the brake B1 engaged and the first clutch C1 and the second clutch C2 released. As a result, the driving force of the electric motor 320 is transmitted to the drive wheels 360 and 360 side via the planetary gear mechanism 330 and the CVT 340, and the vehicle is driven forward only by the driving force of the electric motor 320. Then, in this “motor traveling mode (forward deceleration),” since the ring gear R is fixed by the engagement of the brake B1, the rotation of the output shaft 321 of the electric motor 320 input to the sun gear S is decelerated and output from the carrier C to the CVT 340. As described above, in the hybrid drive device 301 of this embodiment, it is configured the rotation of the output shaft 321 of the electric motor 320 is decelerated and output by the planetary gear mechanism 330, whereby in this “motor traveling mode (forward deceleration),” a large torque may be obtained especially when the vehicle starts without increasing the size of the electric motor 320.

As described above, the ECU 51 shifts the CVT ratio down to Extra-Low during slope climbing, regeneration, or acceleration when the PEAK torque is requested, whereby the CVT output torque at the time of the electric motor CONT torque may be set to be equal to the CVT output torque at the time of the electric motor PEAK torque. This eliminates the need to use a large amount of PEAK torque that does not allow a steady operation, and may provide a motor-driven vehicle having good acceleration, regeneration, and slope climbing abilities without limiting operating conditions. Further, when the PEAK torque is not requested, the shift control according to this embodiment is not performed, and the shift control is continuously executed for the CVT 340 within a predetermined ratio range of the CVT ratio Low to OD.

Regarding the hybrid drive device 301 to which the third embodiment of the disclosure exemplified in FIG. 8 is applied, the same reference numerals as those in FIG. 7 are assigned to the same members, and the description thereof are omitted. The hybrid drive device 301 includes an engine 310, a first electric motor 320-1 and a second electric motor 320-2, a planetary gear mechanism (planetary gear) 330, and a belt-type CVT 340. The output shaft (rotation shaft) 321-1 of the first electric motor 320-1 is connected to the sun gear S of the planetary gear mechanism 330, and the input shaft (first rotation shaft) connected to the drive pulley 341 of the CVT 340 is connected to the carrier C. Further, the ring gear R is connected to the output shaft 311 of the engine 310 via the first clutch C1 and is also connected to the input shaft 342 of the CVT 340 via the second clutch C2. Further, the ring gear R is connected to the output shaft (rotation shaft) 321-2 of the second electric motor 320-2.

Further, an output gear 345 that meshes with the counter gear 347 is provided on the output shaft (second rotation shaft) 344 connected to the driven pulley 343 of the CVT 340. The counter gear 347 meshes with the ring gear 351 of the differential device 350. The differential device 350 distributes the driving force from the counter gear 347 to the left and right drive wheels 360 and 360. A third clutch C3 is provided on the output shaft 344 of the CVT 340 (between the driven pulley 343 and the output gear 345).

That is, in the planetary gear mechanism 330 of the hybrid drive device 301 shown in FIG. 8, the sun gear S, to which the output shaft 321-1 of the first electric motor 320-1 is connected, and the ring gear R to which the output shaft 311 of the engine 310 and the output shaft 321-2 of the second electric motor 320-2 are connected, are input members; and the carrier C connected to the input shaft 342 of the CVT 340 is an output member. Then, the engagement/disengagement of the output shaft 311 of the engine 310 and the ring gear R may be switched by the first clutch C1, and the engagement/disengagement between the carrier C and the ring gear R may be switched by the second clutch C2. Further, the transmission or non-transmission of the driving force from the CVT 340 to the drive wheels 360 and 360 side may be switched by the third clutch C3.

In the hybrid drive device 301, each traveling mode is established depending on the operating state (engagement/disengagement state) of the first to third clutches C1 to C3 and the operating state of the first electric motor 320-1 and the second electric motor 320-2. The shift control according to this embodiment is executed in the following “motor traveling mode (forward deceleration).” Such control and shift control of the hybrid drive device 301 are executed by an ECU 51 (not shown).

In the “motor traveling mode (forward deceleration),” the first electric motor 320-1 is driven forward while the second electric motor 320-2 is turned on (rotated) and the first clutch C1 and the second clutch C2 are released. As a result, the driving force obtained by combining the driving force of the first electric motor 320-1 and the driving force of the second electric motor 320-2 is transmitted to the drive wheels 360 and 360 side via the planetary gear mechanism 330 and the CVT 340, and the driving force of the first electric motor 320-1 and the second electric motor 320-2 causes the vehicle to travel forward. Then, in this “motor traveling mode (forward deceleration),” the rotation of the output shaft 321-1 of the first electric motor 320-1 input to the sun gear S is decelerated and output from the carrier C to the CVT 340. As described above, in the hybrid drive device 301, it is configured the rotation of the output shaft 321-1 of the first electric motor 320-1 is decelerated and output by the planetary gear mechanism 330, whereby in this “motor traveling mode (forward deceleration),” a large torque may be obtained especially when the vehicle starts without increasing the size of the first electric motor 320-1.

Further, in this “motor traveling mode (forward deceleration),” when the first electric motor 320-1 has a predetermined rotation speed N1 (N1>0), the rotation speed of the carrier C becomes 0, and when the rotation speed of the first electric motor 320-1 is increased from there, the rotation speed of the carrier C gradually increases. Therefore, the vehicle may be started by increasing the rotation speed of the first electric motor 320-1 from the predetermined rotation speed N1. As a result, in starting the vehicle by the driving force of the first electric motor 320-1 and the second electric motor 320-2, the vehicle may be started without using the area where the rotation speed of the first electric motor 320-1 or the second electric motor 320-2 rises from 0. Therefore, it is possible to start the vehicle using the highly efficient rotation range of the first electric motor 320-1 and the second electric motor 320-2.

As described above, the ECU 51 shifts the CVT ratio down to Extra-Low during slope climbing, regeneration, or acceleration when the PEAK torque is requested, whereby the CVT output torque at the time of the electric motor CONT torque may be set to be equal to the CVT output torque at the time of the electric motor PEAK torque. This eliminates the need to use a large amount of PEAK torque which does not allow a steady operation, and may provide a motor-driven vehicle having good acceleration, regeneration, and slope climbing abilities without limiting operating conditions. Further, when the PEAK torque is not requested, the shift control according to this embodiment is not performed, and the shift control is continuously executed for the CVT 340 within a predetermined ratio range of the CVT ratio Low to OD.

The disclosure is applicable to the control of electric vehicles and hybrid vehicles including an electric motor and a continuously variable transmission.

What is claimed is:

1. A motor-driven vehicle, comprising:
an electric motor;
a continuously variable transmission provided between the electric motor and a drive wheel; and
a control part that executes a torque control of the electric motor and a shift control of the continuously variable transmission,
wherein the control part:
comprises a control area for the shift control in which an output torque of the continuously variable transmission at the time of a peak torque of the electric motor and the output torque of the continuously variable transmission at the time of a rated torque of the electric motor are equal,
sets an extra low ratio lower than a lowest ratio in a predetermined ratio range for the continuously variable transmission, and
when the peak torque is requested in the electric motor, downshifts a ratio of the continuously variable transmission from the lowest ratio to the extra low ratio while reducing an output torque of the electric motor from the peak torque to the rated torque in the control area.

2. The motor-driven vehicle according to claim 1, wherein when the peak torque is requested in the electric motor, the control part:
sets the output torque of the electric motor to the peak torque,
reduces the output torque of the electric motor from the peak torque to the rated torque and downshifts the ratio of the continuously variable transmission from the lowest ratio to the extra low ratio, and
when a request for the peak torque in the electric motor is released, increases the ratio of the continuously variable transmission from the extra low ratio to the lowest ratio in the predetermined ratio range.

3. The motor-driven vehicle according to claim 1, wherein the peak torque is requested in the electric motor during slope climbing, regeneration, or acceleration of the motor-driven vehicle.

4. The motor-driven vehicle according to claim 2, wherein the peak torque is requested in the electric motor during slope climbing, regeneration, or acceleration of the motor-driven vehicle.

5. The motor-driven vehicle according to claim 1, wherein a reduction mechanism is provided between an output shaft of the electric motor and an input shaft of the continuously variable transmission.

6. The motor-driven vehicle according to claim 2, wherein a reduction mechanism is provided between an output shaft of the electric motor and an input shaft of the continuously variable transmission.

7. The motor-driven vehicle according to claim 3, wherein a reduction mechanism is provided between an output shaft of the electric motor and an input shaft of the continuously variable transmission.

8. The motor-driven vehicle according to claim 4, wherein a reduction mechanism is provided between an output shaft of the electric motor and an input shaft of the continuously variable transmission.

9. The motor-driven vehicle according to claim 1, wherein the electric motor is used in an electric vehicle mode of a hybrid vehicle.

10. The motor-driven vehicle according to claim 2, wherein the electric motor is used in an electric vehicle mode of a hybrid vehicle.

11. The motor-driven vehicle according to claim 3, wherein the electric motor is used in an electric vehicle mode of a hybrid vehicle.

12. The motor-driven vehicle according to claim 4, wherein the electric motor is used in an electric vehicle mode of a hybrid vehicle.

13. The motor-driven vehicle according to claim 5, wherein the electric motor is used in an electric vehicle mode of a hybrid vehicle.

14. The motor-driven vehicle according to claim 6, wherein the electric motor is used in an electric vehicle mode of a hybrid vehicle.

15. The motor-driven vehicle according to claim 7, wherein the electric motor is used in an electric vehicle mode of a hybrid vehicle.

16. The motor-driven vehicle according to claim 8, wherein the electric motor is used in an electric vehicle mode of a hybrid vehicle.

17. A control method of a motor-driven vehicle, wherein motor-driven vehicle comprises:
an electric motor;
a continuously variable transmission provided between the electric motor and a drive wheel; and
a control part that executes a torque control of the electric motor and a shift control of the continuously variable transmission,
wherein the control part:
comprises a control area for the shift control in which an output torque of the continuously variable transmission at the time of a peak torque of the electric motor and the output torque of the continuously variable transmission at the time of a rated torque of the electric motor are equal,
sets an extra low ratio lower than a lowest ratio in a predetermined ratio range for the continuously variable transmission, and
when the peak torque is requested in the electric motor, downshifts a ratio of the continuously variable transmission from the lowest ratio to the extra low ratio while reducing an output torque of the electric motor from the peak torque to the rated torque in the control area.

18. The control method of the motor-driven vehicle according to claim 17, wherein when the peak torque is requested in the electric motor, the control part:
sets the output torque of the electric motor to the peak torque,
reduces the output torque of the electric motor from the peak torque to the rated torque and downshifts the ratio of the continuously variable transmission from the lowest ratio to the extra low ratio, and
when a request for the peak torque in the electric motor is released, increases the ratio of the continuously variable transmission from the extra low ratio to the lowest ratio in the predetermined ratio range.

19. The control method of the motor-driven vehicle according to claim 17, wherein the peak torque is requested in the electric motor during slope climbing, regeneration, or acceleration of the motor-driven vehicle.

20. The control method of the motor-driven vehicle according to claim 18, wherein the peak torque is requested in the electric motor during slope climbing, regeneration, or acceleration of the motor-driven vehicle.
